(19) United States
(12) Patent Application Publication
(10) Pub. No.: US 2015/0310475 A1
(43) Pub. Date: Oct. 29, 2015

(54) METHOD AND SYSTEM FOR PREDICTING COUPON REDEMPTION

(71) Applicant: MasterCard International Incorporated, Purchase, NY (US)

(72) Inventor: Jason A. FELDMAN, New York, NY (US)

(73) Assignee: MasterCard International Incorporated, Purchase, NY (US)

(21) Appl. No.: 14/261,598

(22) Filed: Apr. 25, 2014

(51) Int. Cl. G06Q 30/02

(52) U.S. Cl. CPC G06Q 30/0225

(57) ABSTRACT

A method for identifying coupon redemption characteristics includes: storing a plurality of consumer profiles, each consumer profile including data related to a consumer including a consumer identifier and a plurality of coupon redemption data entries, each coupon redemption data entry including a coupon identifier and coupon data related to a coupon redeemed by the related consumer; receiving an authorization request for a payment transaction, the authorization request including a specific consumer identifier and a redeemed coupon identifier; identifying a specific consumer profile where the included consumer identifier corresponds to the specific consumer identifier; creating, in the specific consumer profile, a new coupon redemption data entry corresponding to a coupon corresponding to the redeemed coupon identifier; and identifying at least one coupon redemption characteristic based on the coupon data included in each of the coupon redemption data entries included in the specific consumer profile.

### FIELD

The present disclosure relates to the predicting of coupon redemption characteristics of a consumer, specifically the use of coupon redemption characteristics identified based on coupon redemption history to be used for predicting of future coupon redemption behavior.

### BACKGROUND

Merchants, manufacturers, retailers, and other entities often utilize coupons (e.g., offers, deals, discounts, etc.) in order to increase business traffic. Coupons may offer consumers discounts for products (e.g., goods and/or services) to encourage the consumer to not only purchase the discounted products, but also to view additional wares offered by the corresponding merchant with a hope that the consumer may also purchase additional items. In some instances, coupons may be used to encourage a consumer to try a new product or manufacturer that the consumer may not otherwise try, which could gain a new, repeat customer for a merchant and/or manufacturer.

However, the distribution of coupons to consumers may be costly for many merchants or other entities in both time and resources. The distribution of coupons themselves may come at a significant expense, and thus, many merchants or other coupon providers often have a goal to distribute coupons to consumers that are most likely to redeem the coupons. By distributing coupons only to those consumers likely to redeem them, merchants may minimize the expenses incurred for the production and distribution of coupons while maximizing the return from the coupons. Further, by delivering coupons to potential customers that have an interest in them, the potential for fatigue or over exposure to the potential customer may be reduced

Some methods and systems have been developed that attempt to use coupon redemption history of a consumer in addition to other data to generate a behavioral profile of the consumer for use in identifying new offers for distribution, such as the methods and systems described in U.S. patent application Ser. No. 13/793,616, entitled “System and Method for Offer Targeting Based on Offer Redemption,” by Andrea Gilman et al., filed on Mar. 11, 2013, which is herein incorporated by reference in its entirety. However, such systems often rely on receiving redemption data secondhand, which may be both inaccurate and outdated. In addition, the behavioral profile generated by such systems are often tailored solely to propensities for redemption of a type of coupon by a user, which may ignore other valuable data and characteristics that may be gleaned from the offer data for offers redeemed by a consumer.

Thus, there is a need for a technical solution to receive accurate coupon redemption data in real-time and use such data to identify characteristics for the corresponding consumer that may be utilized by coupon providers for the identification of future coupons to be redeemed to the consumer.

### SUMMARY

The present disclosure provides a description of systems and methods for the identification of coupon redemption characteristics.

A method for identifying coupon redemption characteristics includes: storing, in a consumer database, a plurality of consumer profiles, wherein each consumer profile includes data related to a consumer including at least a consumer identifier and a plurality of coupon redemption data entries, each coupon redemption data entry including a coupon identifier and coupon data related to a coupon redeemed by the related consumer; receiving, by a receiving device, an authorization request for a payment transaction, wherein the authorization request includes at least a specific consumer identifier and a redeemed coupon identifier; identifying, in the consumer database, a specific consumer profile where the included consumer identifier corresponds to the specific consumer identifier; creating, in the specific consumer profile, a new coupon redemption data entry corresponding to a coupon corresponding to the redeemed coupon identifier; and identifying, by a processing device, at least one coupon redemption characteristic based on the coupon data included in each of the coupon redemption data entries included in the specific consumer profile.

A system for identifying coupon redemption characteristics includes a consumer database, a receiving device, and a processing device. The consumer database is configured to store a plurality of consumer profiles, wherein each consumer profile includes data related to a consumer including at least a consumer identifier and a plurality of coupon redemption data entries, each coupon redemption data entry including a coupon identifier and coupon data related to a coupon redeemed by the related consumer. The receiving device is configured to receive an authorization request for a payment transaction, wherein the authorization request includes at least a specific consumer identifier and a redeemed coupon identifier. The processing device is configured to: identify, in the consumer database, a specific consumer profile where the included consumer identifier corresponds to the specific consumer identifier; create, in the specific consumer profile, a new coupon redemption data entry corresponding to a coupon corresponding to the redeemed coupon identifier; and identify at least one coupon redemption characteristic based on the coupon data included in each of the coupon redemption data entries included in the specific consumer profile.

### BRIEF DESCRIPTION OF THE DRAWING FIGURES

The scope of the present disclosure is best understood from the following detailed description of exemplary embodiments when read in conjunction with the accompanying drawings.

FIG. 1 is a high level architecture illustrating a system for identification of coupon redemption characteristics based on historic coupon redemption data in accordance with exemplary embodiments.

FIG. 2 is a block diagram illustrating the processing server of FIG. 1 for the identification of consumer coupon redemption characteristics in accordance with exemplary embodiments.

FIG. 3 is a block diagram illustrating the consumer database of the processing server of FIG. 2 for the storage of consumer profiles in accordance with exemplary embodiments.

FIG. 4 is a flow diagram illustrating a process for the receipt and identification of coupon data for a redeemed coupon in accordance with exemplary embodiments.

FIG. 5 is a flow diagram illustrating a method for identifying coupon redemption characteristics in a consumer profile using coupon redemption data in accordance with exemplary embodiments.

FIG. 6 is a flow chart illustrating an exemplary method for identifying coupon redemption characteristics in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for the Identification of Coupon Redemption Characteristics

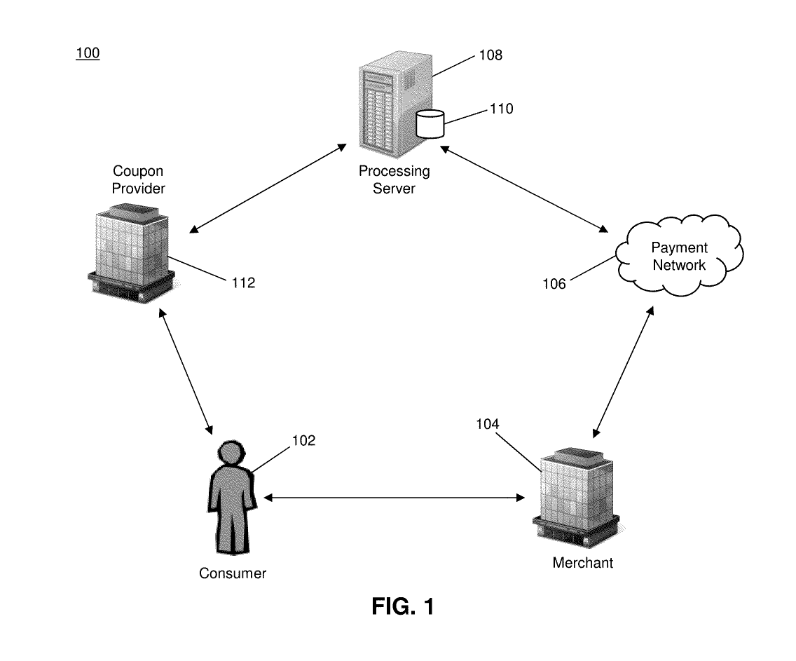

FIG. 1 illustrates a system 100 for the identification of coupon redemption characteristics for a consumer based on historical coupon redemption data associated with the consumer.

The system 100 may include a consumer 102. The consumer 102 may be in possession of or be otherwise associated with a coupon. The consumer 102 may use the coupon during a payment transaction with a merchant 104, such as for the purchase of discounted goods or services from the merchant 104. The consumer 102 may furnish the coupon to the merchant 104, who may then read the coupon or otherwise obtain the corresponding coupon data. If redemption of the coupon is successful, the transaction may be discounted accordingly. Methods and systems for reading coupon data and processing the redemption of a coupon will be apparent to persons having skill in the relevant art.

The merchant 104, and/or an acquirer associated with the merchant 104, may submit an authorization request for the payment transaction to a payment network 106 for processing. The authorization request may include transaction data (e.g., a transaction amount, time and/or date, geographic location, product data, etc.), a consumer identifier (e.g., an account identifier corresponding to a payment account associated with the consumer 102 used to fund the transaction, which can be the account number or a separate alphanumeric identifier linked or otherwise associated with the consumer, particularly when there are multiple consumers associated with a payment account), and a coupon identifier corresponding to the coupon presented and redeemed by the consumer 102. The payment network 106 may process the payment transaction using methods and systems that will be apparent to persons having skill in the relevant art. In some embodiments, the payment network 106 may process the redemption of the coupon instead of the merchant 104 and may then process the payment transaction using traditional methods.

The payment network 106 may also transmit a copy of the authorization request, or at least a portion of the data contained therein, to a processing server 108. The processing server 108, discussed in more detail below, may receive the authorization request including the consumer identifier and coupon identifier. The processing server 108 may identify a consumer profile associated with the consumer 102, discussed in more detail below, that is stored in a consumer database 110, also discussed in more detail below, using the consumer identifier. The processing server 108 may then update the consumer profile to include coupon data corresponding to the redeemed coupon based on the coupon identifier.

In some embodiments, the coupon data may be identified via a coupon database stored by the processing server 108 and/or a coupon provider 112 that may have distributed the coupon to the consumer 102. In other embodiments, the processing server 108 may request the coupon data from the coupon provider 112, such as by providing the coupon identifier in the request for identification of the corresponding coupon data. In another embodiment, the authorization request may include the coupon data corresponding to the redeemed coupon (e.g., read and/or obtained by the merchant 104 when the coupon is redeemed).

The coupon data may include any data corresponding to the coupon that is suitable for use in performing the functions as discussed herein as will be apparent to persons having skill in the relevant art, such as coupon type, coupon category, coupon amount, transaction modifier, coupon value, merchant data, manufacturer data, product data, start date, expiration date, quantity, time and/or date of redemption, and restrictions or limits on redemption. The processing server 108 may then use the coupon data stored in the consumer profile for each coupon redeemed by the consumer 102 to identify one or more consumer redemption characteristics. The consumer redemption characteristics may be characteristics associated with the consumer 102 based on past redeemed coupons that may be used to identify future coupons for distribution to the consumer 102, as discussed in more detail below.

The processing server 108 may then use the coupon redemption characteristics to identify new coupons (e.g., received from the coupon provider 112) for distribution, which may then be distributed to the consumer 102. In some embodiments, the processing server 108 may transmit the consumer profile, or at least the identified coupon redemption characteristics for the consumer 102, to the coupon provider 112. The coupon provider 112 may then identify new coupons for distribution to the consumer 102 based on the received characteristics, and may then distribution the identified coupons to the consumer 102 using methods and systems that will be apparent to persons having skill in the relevant art.

By receiving authorization requests directly from the payment network 106, the processing server 108 may be able to update consumer coupon redemption characteristics in real-time. In addition, because the data included in the authorization request originates at the merchant 104 where the coupon was redeemed, the data received by the processing server 108 may be more accurate than in traditional systems, which may result in a more efficient and effective system. The processing server 108 may thus be able to provide for the identification of consumer redemption characteristics more efficiently than traditional methods and systems. In addition, the identification of characteristics based on data for each redeemed coupon may result in more comprehensive and detailed, and thus more effective, data regarding a consumer's coupon redemption behavior over traditional systems and methods.

### Processing Server

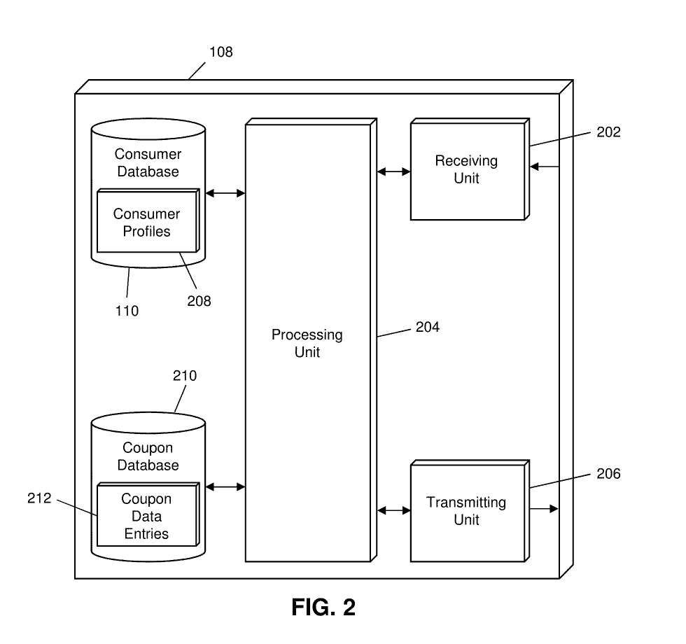

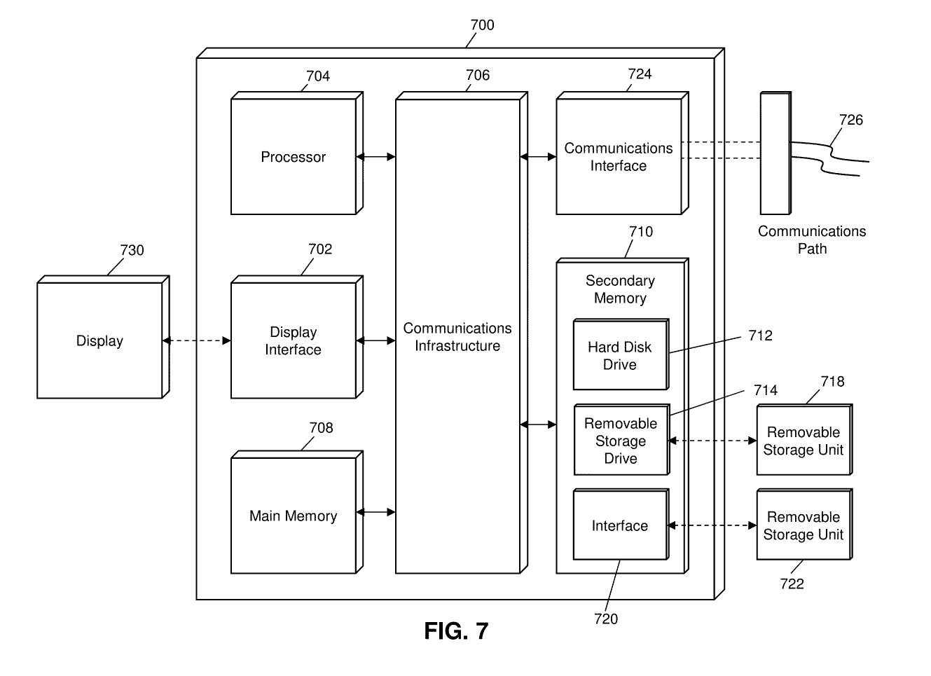

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive an authorization request from the payment network 106 including at least a consumer identifier and a coupon identifier. The processing server 108 may further include a processing unit 204, which may be configured to identify a consumer profile 208 stored in the consumer database 110 based on the consumer identifier included in the authorization request. The identified consumer profile 208, discussed in more detail below, may be associated with the consumer 102 involved in the payment transaction.

The processing unit 204 may be further configured to identify coupon data corresponding to the coupon redeemed in the payment transaction via the coupon identifier included in the received authorization request. The coupon identifier may be a unique value associated with the corresponding coupon that may be used for identification. Values that may be used as the coupon identifier may include identification numbers, universal product codes, stock-keeping units, and other suitable values as will be apparent to persons having skill in the relevant art.

In one embodiment, the coupon data may be included in the authorization request. In another embodiment, the processing server 108 may include a transmitting unit 206. The transmitting unit 206, which may be configured to transmit data over one or more networks via one or more network protocols, may transmit a request for coupon data to the coupon provider 112, the request including the coupon identifier. The receiving unit 202 may then receive the requested coupon data from the coupon provider 112.

In yet another embodiment, the processing server 108 may include a coupon database 210. The coupon database 210 may include a plurality of coupon data entries 212. Each coupon data entry 212 may include data related to a coupon including at least a coupon identifier and coupon data. In some embodiments, the coupon data entries 212 and/or the data included therein may be received, by the receiving unit 202, from the coupon provider 212. The processing unit 204 may identify a coupon data entry 212 that includes the coupon identifier included in the authorization request, and may identify the coupon data included therein.

The processing unit 204 may be further configured to update coupon redemption data included in the identified consumer profile 208 to include the identified coupon data corresponding to the redeemed coupon. The processing unit 204 may also be configured to calculate one or more coupon redemption characteristics for the consumer 102, which may be stored in the consumer profile 208. The coupon redemption characteristics may include a propensity for the consumer 102 to redeem any coupon and/or a propensity for the consumer 102 to redeem a coupon based on one or more criteria including: coupon category, coupon type, coupon value, product category, merchant category, merchant, manufacturer, manufacturer category, redemption period, redemption location, and coupon quantity. Additional criteria and/or characteristics that may be identified by the processing unit 204 based on redeemed coupon data will be apparent to persons having skill in the relevant art.

In some embodiments, the processing server 108 may also be configured to store and utilize demographic characteristics for each consumer 102. In such an embodiment, the receiving unit 202 may be configured to receive demographic characteristics associated with the consumer 102 from a third party, such as a demographic tracking agency. The processing unit 204 may be configured to identify the corresponding consumer profile 208 and store the demographic characteristics in the consumer profile 208. In an exemplary embodiment, the associated consumer 102 may be required to provide consent for the obtaining and storage of their associated demographic characteristics.

In another embodiment, the demographic characteristics received by the receiving unit 202 and stored in the consumer profile 208 may not include any personally identifiable information or may otherwise be rendered non-personally identifiable by the processing unit 204. Additional information regarding personally identifiable information and methods and systems for the rendering non-personal, receipt, and storage of such information may be found in U.S. patent application Ser. No. 13/437,987, entitled “Protecting Privacy in Audience Creation,” by Curtis Villars et al., filed on Apr. 3, 2012, which is herein incorporated by reference in its entirety.

In some embodiments, the receiving unit 202 may be configured to receive a request from the coupon provider 112 for one or more coupon redemption characteristics. The request may include one or more requested coupon redemption characteristics and information used for the identification of the consumer 102, such as the consumer identifier or a plurality of demographic characteristics. In instances where the request includes a plurality of demographic characteristics, the processing unit 204 may identify at least one consumer profile 208 including the plurality of demographic characteristics, which may enable the processing server 108 to identify consumer 102 who are included in a target market for the coupon provider 112.

The processing unit 204 may then identify and/or generate the requested one or more coupon redemption characteristics for the identified consumer profile(s) 208. The transmitting unit 206 may transmit, to the coupon provider 112, a response to the received request including the requested one or more coupon redemption characteristics. In some instances, such as if the request does not specify a consumer but includes demographic characteristics, the transmitting unit 206 may further transmit a consumer identifier and/or contact information (e.g., an e-mail address, phone number, etc., which may be provided by the consumer 102 for use in receiving targeted coupons) to the coupon provider 112 for use in distributing coupons to the corresponding consumers 102.

### Consumer Database and Profiles

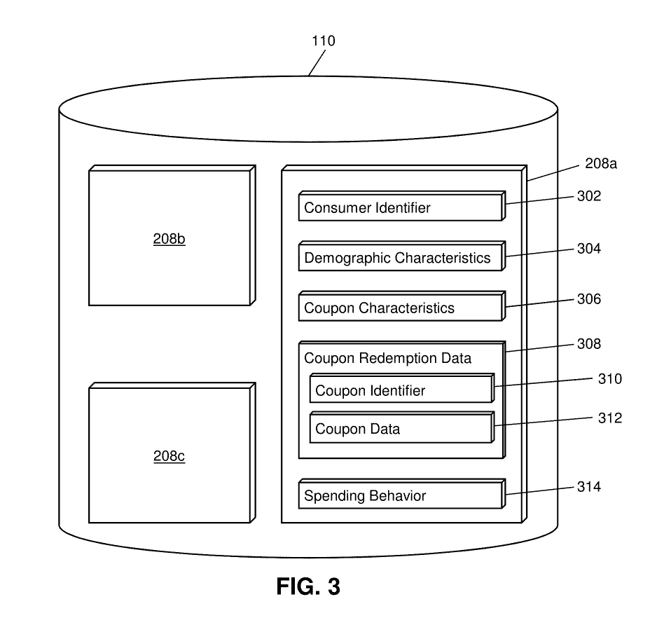

FIG. 3 illustrates the coupon database 110 stored in the processing server 108. As discussed above, the coupon database 110 may be configured to store a plurality of consumer profiles 208. Each consumer profile 208 may include at least a consumer identifier 302, coupon characteristics 306, and coupon redemption data 308. In some embodiments, each consumer profile 208 may further include demographic characteristics 304.

The consumer identifier 302 may be a unique value suitable for the identification of a consumer 102 corresponding to the respective consumer profile 208. The consumer identifier 302 may be an identification number, a payment account number corresponding to a payment account associated with the consumer 102, a phone number, an e-mail address, a street address, a name, combinations thereof or any other suitable value that may be unique to a consumer 102 as will be apparent to persons having skill in the relevant art.

The demographic characteristics 304 may include demographic data associated with the related consumer 102 that may be used, in connection with the coupon characteristics 306, for the identification of coupons to be distributed to the related consumer 102. The demographic characteristics 304 may include age, gender, income, zip code, postal code, residential status, residential type, education, familial status, occupation, and other suitable demographics that will be apparent to persons having skill in the relevant art. In some embodiments, the demographic characteristics 304 may be received and stored in the consumer profile 208 with the consent of the related consumer 102. In other embodiments, the demographic characteristics 304 may be designed to not include any personally identifiable information.

The coupon characteristics 306 may be, as discussed above, characteristics based on redeemed coupon data that may be used to identify coupons for future distribution to the related consumer 102. The coupon characteristics 306 may include propensities for redemption, rates of redemption, rates of non-use of offers, and other similar characteristics and may be based on a plurality of criteria, such as coupon value, coupon type, merchant data, manufacturer data, product data, coupon availability, time and/or date, geographic location, etc. For example, a coupon characteristic 306 may identify the related consumer 102 as more likely to redeem a coupon received on a weekend rather than a weekday, as well as more likely to redeem a coupon for a set value discount rather than a percentage discount.

The coupon redemption data 308 may include information regarding coupons previously redeemed by the related consumer 102. The coupon redemption data 308 may include at least a coupon identifier 310 and coupon data 312 for each redeemed coupon. The coupon identifier 310, as discussed above, may be a unique value associated with the redeemed coupon used for identification, such as an identification number. The coupon data 312 may be data associated with the redeemed coupon, such as a coupon category, coupon type, coupon value, product category, merchant category, merchant, manufacturer, start date, expiration date, quantity, date of redemption, time of redemption, transaction amount at time of redemption, one or more limits or restrictions on redemption, or other suitable information.

In some embodiments, the coupon redemption data 308 may also include product data corresponding to one or more products purchased (e.g., at a discount) using the redeemed coupon. The product data may include a universal product code, stock-keeping unit, serial number, manufacturer part number, international standard book number, product category, manufacturer, purchase amount, color, or other data that may be useful for performing the functions discussed herein as will be apparent to persons having skill in the relevant art.

In some embodiments, each consumer profile 208 may further include spending behavior 314. The spending behavior 314 may include a behavior profile for spending by the related consumer 102. In some instances, the spending behavior 314 may be based on payment transactions involving the related consumer 102 using redeemed coupons. In other instances, the spending behavior 314 may be based on any payment transactions involving the related consumer 102, including payment transactions that are processed without a coupon being redeemed. In one embodiment, the spending behavior 314 may include transaction data for the payment transactions, such as transaction amounts, merchant data, product data, etc. In another embodiment, the spending behavior 314 may include a behavioral profile based on transaction data for the payment transactions.

The spending behavior 314 may include propensities to spend for the related consumer 102 for a plurality of categories. For instance, the spending behavior 314 may include an overall propensity to spend, a propensity to spend for specific product manufacturers or categories (e.g., Apple® products, smartphones, sporting goods, etc.), a propensity to spend for specific merchants or merchant categories, a propensity to spend amounts, a propensity to spend with coupons of different types or values, a propensity to spend at specific times, dates, geographic locations, etc., a propensity to travel to spend for a plurality of distances, etc. Additional behaviors that may be associated with a consumer 102 based on transaction data including payment transactions where coupons were and/or were not redeemed will be apparent to persons having skill in the relevant art.

In one example, the transaction data associated with spending behavior 314 may be suitable for the identification of future offers to be redeemed to the related consumer 102 in conjunction with the coupon redemption data 308. For instance, coupons for the purchase of designer jeans may be distributed to consumers who show a propensity to purchase designer jeans in their spending behavior 314. In some instances, the transaction data for each consumer 102 may be analyzed in addition to their identified propensity. For example, the coupon for designer jeans may not be distributed to a consumer 102 whose transaction data shows a recent purchase for designer jeans, which may indicate that they are less likely to use the coupon. Similarly, the coupon may be distributed to a consumer 102 who has a propensity to buy designer jeans, who regularly redeems coupons for designer jeans, and who has no history of purchasing designer jeans recently. Similarly, purchase history may be used in distribution of coupons generally. For instance, coupons may be distributed to the consumer 102 based on the life span of a particular product, such as one for which the consumer 102 previously redeemed a coupon. For example, a consumer 102 that uses a coupon to purchase laundry detergent may receive another coupon for laundry detergent at the estimated end of the detergent's life span, e.g., 120 days. In some instances, the product life span may be based on consumer characteristics, such as a shorter or longer life span for a product for individuals, couples, families, etc.

In another example, a coupon may be distributed to the consumer 102 based on location data included in their transaction data. For instance, a coupon may be distributed to the consumer 102 for a merchant 104 located near the consumer's usual lunch spot, as indicated by repeated transactions near the same time and geographic location. In such an instance, the coupon may be for a merchant 104 or product to which the consumer 102 has a history of redemption. In some embodiments, coupons may be distributed to the consumer 102 based on their preferred channel for purchasing of a product. For instance, if the consumer 102 prefers to purchase electronics via the Internet, but purchase clothing at a brick and mortar store, coupons for electronics may be distributed to the consumer 102 for e-commerce transactions while coupons for clothing may be for in-store purchases.

### Process for the Identification of Redeemed Coupon Data

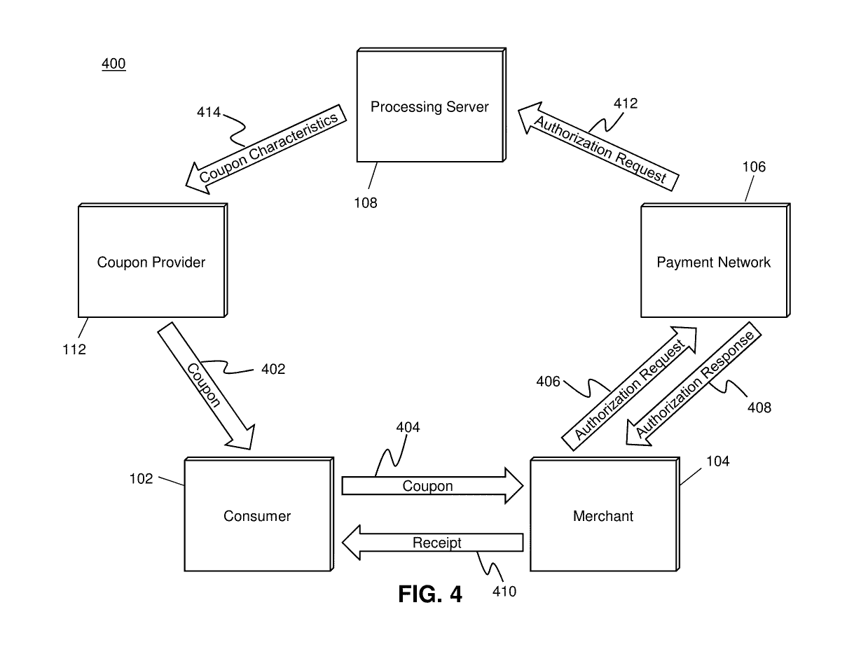

FIG. 4 illustrates a process 400, using the system 100, for the identification of coupon data for a redeemed coupon, which may be used to identify coupon redemption characteristics for the consumer 102.

In step 402, the coupon provider 112 may distribute a coupon to the consumer 102. The coupon may be distributed using methods and systems that will be apparent to persons having skill in the relevant art. In some instances, the coupon may be selected based on coupon redemption characteristics identified for the consumer 102 using the methods and systems discussed herein. In step 404, the consumer 102 may conduct a payment transaction with the merchant 104 and furnish the coupon for use in the transaction.

The merchant 104 may discount the transaction using the coupon and then, in step 406, may submit (e.g., via an acquirer) an authorization request to the payment network 106. The authorization request may include transaction data for the payment transaction, a consumer identifier, and a coupon identifier. In some embodiments, the authorization request may also include coupon data for the redeemed coupon. The payment network 106 may then process the payment transaction using methods and systems that will be apparent to persons having skill in the relevant art, and, in step 408, provide an authorization response indicating approval of the transaction to the merchant 104.

The merchant 104 may then, in step 410, furnish a receipt and/or the transacted-for products to the consumer 102 to finalize the transaction. Following the processing of the payment transaction, the payment network 106 may, in step 412, transmit a copy of the authorization request to the processing server 108. The processing server 108 may then use the consumer identifier and coupon identifier included in the authorization request to identify and store coupon data corresponding to the redeemed coupon in a consumer profile 208 associated with the consumer 102, such as using the method 500 discussed and illustrated below.

In step 414, the processing server 108 may transmit the coupon characteristics 306 and/or any other suitable data to the coupon provider 112 for use in identifying future coupons for transmission to the consumer 102. For instance, the coupon provider 112 may identify future coupons based on the coupon characteristics 306, coupon redemption data 308, demographic characteristics 304, spending behavior 314, etc. The coupon provider 112 may also use additional criteria for identifying coupons for distribution to the consumer 102, such as method of distribution, merchant data (e.g., geographic location, merchant type, merchant category, store hours, store size, etc.), coupon data, or other suitable criteria as will be apparent to persons having skill in the relevant art.

### Process for Identifying Coupon Redemption Characteristics

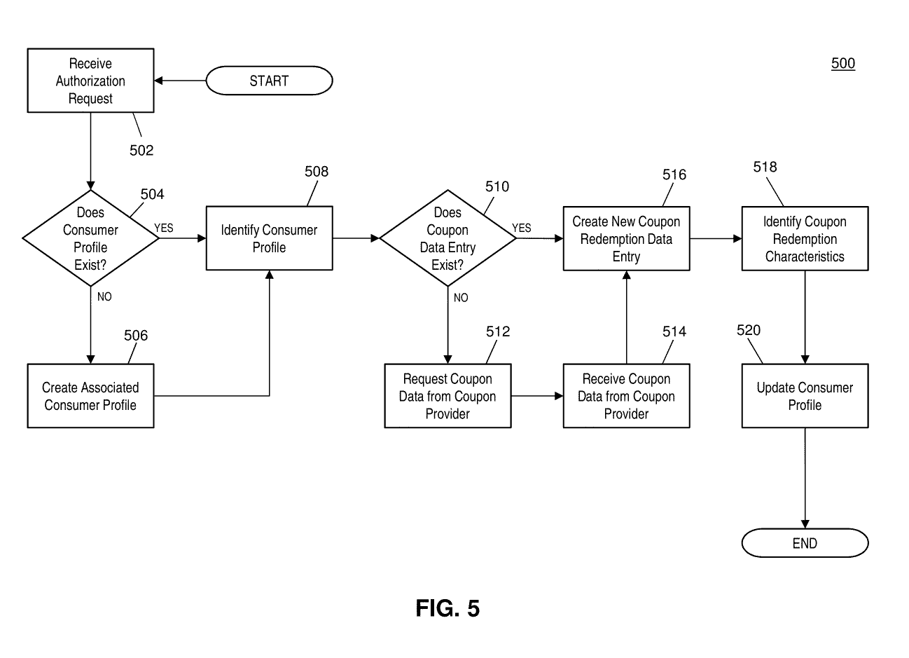

FIG. 5 illustrates a method 500 for the identification of coupon redemption characteristics for a consumer based on coupon redemption data, such as coupon redemption data received using the method 400 illustrated in FIG. 4.

In step 502, the receiving unit 202 of the processing server 108 may receive the authorization request from the payment network 106 (e.g., step 412 of the process 400). The authorization request may include at least a consumer identifier associated with the consumer 102 involved in the payment transaction and a coupon identifier corresponding to the coupon redeemed by the consumer 102 in the payment transaction.

In step 504, the processing unit 204 may determine if a consumer profile 208 already exists in the consumer database 110 corresponding to the consumer 102. The determination may be made by identifying if a consumer profile 208 exists in the consumer database 110 where the included consumer identifier 302 corresponds to the consumer identifier included in the received authorization request. If no such consumer profile 208 exists, then, in step 506, the processing unit 204 may create a consumer profile 208 including the consumer identifier included in the authorization request and store the created consumer profile 208 in the consumer database 110.

Once a consumer profile 208 associated with the consumer 102 has been created and/or its existed detected, then, in step 508, the processing unit 204 may identify the consumer profile 208 associated with the consumer 102 using the consumer identifier included in the authorization request. In step 510, the processing unit 204 may determine if a coupon data entry 212 corresponding to the redeemed coupon exists in the coupon database 210 using the coupon identifier included in the received authorization request.

If no coupon data entry 212 exists, then, in step 512, the transmitting unit 206 may transmit a request for coupon data to the coupon provider 112. The request may include at least the coupon identifier included in the received authorization request. The coupon provider 112 may identify the coupon data associated with the redeemed coupon and then transmit the data to the processing server 108. In step 514, the receiving unit 202 may receive the coupon data from the coupon provider. In some embodiments, the processing unit 204 may create and store a new coupon data entry 212 in the coupon database 210 including the received coupon data and the coupon identifier.

Once the processing server 108 has identified the coupon data for the redeemed coupon (e.g., in the coupon data entry 212 or received from the coupon provider 112), then, in step 516, the processing unit 204 may create a new coupon redemption data entry 308. The coupon redemption data entry may include the identified coupon data and the coupon identifier included in the received authorization request. The created coupon redemption data entry may be stored in the coupon redemption data 308 of the consumer profile 208 corresponding to the consumer 102.

In step 514, the processing unit 204 may identify one or more coupon redemption characteristics 306 based on the coupon redemption data 308 included in the consumer profile 208. In some embodiments, the one or more coupon redemption characteristics 306 may be further based on demographic characteristics 304 included in the consumer profile 208. In step 516, the processing unit 204 may update the consumer profile 208 to include the identified coupon redemption characteristics 306.

### Exemplary Method for Identifying Coupon Redemption Characteristics

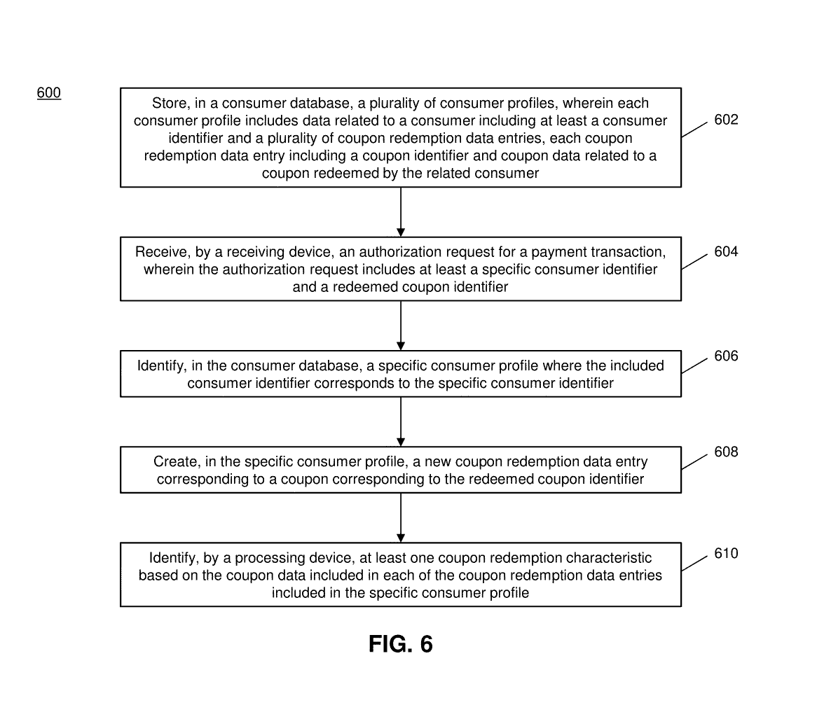

FIG. 6 illustrates a method 600 for identifying coupon redemption characteristics for a consumer based on at least coupon redemption data.

In step 602, a plurality of consumer profiles (e.g., the consumer profiles 208) may be stored in a consumer database (e.g., the consumer database 110), wherein each consumer profile 208 includes data related to a consumer (e.g., the consumer 102) including at least a consumer identifier (e.g., the consumer identifier 302) and a plurality of coupon redemption data entries (e.g., the coupon redemption data 308), each coupon redemption data entry including a coupon identifier (e.g., the coupon identifier 310) and coupon data (e.g., the coupon data 312) related to a coupon redeemed by the related consumer 102. In one embodiment, the coupon data 312 may include at least one of: a coupon category, coupon type, coupon value, product category, merchant category, merchant, manufacturer, start date, expiration date, quantity, date of redemption, time of redemption, and restriction on redemption.

In step 604, an authorization for a payment transaction may be received, by a receiving device (e.g., the receiving unit 202), wherein the authorization request includes at least a specific consumer identifier and a redeemed coupon identifier. In one embodiment, the authorization request may further include product data. In step 606, a specific consumer profile 208 may be identified, in the consumer database 210, where the included consumer identifier 302 corresponds to the specific consumer identifier.

In step 608, a new coupon redemption data entry may be created, in the specific consumer profile 208, corresponding to a coupon corresponding to the redeemed coupon identifier. In embodiments where the authorization request may further include product data, the new coupon redemption data entry may further include the product data. In a further embodiment, the product data may include at least one of: a universal product code, stock-keeping unit, serial number, manufacturer part number, international standard book number, product category, manufacturer, purchase amount, and color. In some embodiments, creating a new coupon redemption data entry may include identifying, in a coupon database (e.g., the coupon database 210), a coupon data entry (e.g., the coupon data entry 212) corresponding to the coupon including redeemed coupon data and the redeemed coupon identifier, and wherein the coupon data included in the new coupon redemption data entry includes the redeemed coupon data in the identified coupon data entry 212.

In step 610, at least one coupon redemption characteristic (e.g., the coupon characteristics 306) may be identified, by a processing device (e.g., the processing unit 204), based on the coupon data included in each of the coupon redemption data entries included in the specific consumer profile 208. In some embodiments, the at least one coupon redemption characteristic 306 may include a propensity for the related consumer 102 to redeem any coupon and/or a propensity to redeem a coupon based on at least one of: a coupon category, a coupon type, a coupon value, a product category, a merchant category, a merchant, a manufacturer, a redemption period, a redemption location, and a coupon quantity. In one embodiment, the method 600 may further include associating, in the consumer database 110, the identified at least one coupon redemption characteristic 306 with the specific consumer profile 208.

In some embodiments, each consumer profile 208 may further include a plurality of demographic characteristics (e.g., the demographic characteristics 304). In a further embodiment, the at least one coupon redemption characteristic 306 may be further based on the plurality of demographic characteristics 304 included in the specific consumer profile 208. In another further embodiment, the plurality of demographic characteristics 304 may include at least one of: age, gender, income, zip code, postal code, residential status, residential type, education, familial status, and occupation. In an exemplary embodiment, the plurality of demographic characteristics 304 may not be personally identifiable to the related consumer 102.

### Computer System Architecture

FIG. 7 illustrates a computer system 700 in which embodiments of the present disclosure, or portions thereof, may be implemented as computer-readable code. For example, the processing server 108.1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 704 may be a special purpose or a general purpose processor device. The processor 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying coupon redemption characteristics. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying coupon redemption characteristics, comprising:
storing, in a consumer database, a plurality of consumer profiles, wherein each consumer profile includes data related to a consumer including at least a consumer identifier and a plurality of coupon redemption data entries, each coupon redemption data entry including a coupon identifier and coupon data related to a coupon redeemed by the related consumer;
receiving, by a receiving device, an authorization request for a payment transaction, wherein the authorization request includes at least a specific consumer identifier and a redeemed coupon identifier;
identifying, in the consumer database, a specific consumer profile where the included consumer identifier corresponds to the specific consumer identifier;
creating, in the specific consumer profile, a new coupon redemption data entry corresponding to a coupon corresponding to the redeemed coupon identifier; and
identifying, by a processing device, at least one coupon redemption characteristic based on the coupon data included in each of the coupon redemption data entries included in the specific consumer profile.

2. The method of claim 1, further comprising:
associating, in the consumer database, the identified at least one coupon redemption characteristic with the specific consumer profile.

3. The method of claim 1, wherein the at least one coupon redemption characteristic includes a propensity for the related consumer to redeem any coupon and/or a propensity to redeem a coupon based on at least one of: a coupon category, a coupon type, a coupon value, a product category, a merchant category, a merchant, a manufacturer, a redemption period, a redemption location, and a coupon quantity.

4. The method of claim 1, wherein the coupon data includes at least one of: a coupon category, a coupon type, a coupon value, a product category, a merchant category, a merchant, a manufacturer, a start date, an expiration date, a quantity, date of redemption, time of redemption, and a restriction on redemption.

5. The method of claim 1, wherein the authorization request further includes product data, and wherein the new coupon redemption data entry includes the product data.

6. The method of claim 5, wherein the product data includes at least one of: a universal product code, a stock-keeping unit, a serial number, a manufacturer part number, an international standard book number, a product category, a manufacturer, a purchase amount, and a color.

7. The method of claim 1, wherein each consumer profile further includes a plurality of demographic characteristics.

8. The method of claim 7, wherein the at least one coupon redemption characteristic are further based on the plurality of demographic characteristics included in the specific consumer profile.

9. The method of claim 7, wherein the plurality of demographic characteristics includes at least one of: age, gender, income, zip code, postal code, residential status, residential type, education, familial status, and occupation.

10. The method of claim 7, wherein the plurality of demographic characteristics are not personally identifiable to the related consumer.

11. The method of claim 1, wherein creating a new coupon redemption data entry includes identifying, in a coupon database, a coupon data entry corresponding to the coupon including redeemed coupon data and the redeemed coupon identifier, and wherein the coupon data included in the new coupon redemption data entry includes the redeemed coupon data in the identified coupon data entry.

12. A system for identifying coupon redemption characteristics, comprising:
a consumer database configured to store a plurality of consumer profiles, wherein each consumer profile includes data related to a consumer including at least a consumer identifier and a plurality of coupon redemption data entries, each coupon redemption data entry including a coupon identifier and coupon data related to a coupon redeemed by the related consumer;
a receiving device configured to receive an authorization request for a payment transaction, wherein the authorization request includes at least a specific consumer identifier and a redeemed coupon identifier; and
a processing device configured to
identify, in the consumer database, a specific consumer profile where the included consumer identifier corresponds to the specific consumer identifier,
create, in the specific consumer profile, a new coupon redemption data entry corresponding to a coupon corresponding to the redeemed coupon identifier, and
identify at least one coupon redemption characteristic based on the coupon data included in each of the coupon redemption data entries included in the specific consumer profile.

13. The system of claim 12, wherein the processing device is further configured to associate, in the consumer database, the identified at least one coupon redemption characteristic with the specific consumer profile.

14. The system of claim 12, wherein the at least one coupon redemption characteristic includes a propensity for the related consumer to redeem any coupon and/or a propensity to redeem a coupon based on at least one of: a coupon category, a coupon type, a coupon value, a product category, a merchant category, a merchant, a manufacturer, a redemption period, a redemption location, and a coupon quantity.

15. The system of claim 12, wherein the coupon data includes at least one of: a coupon category, a coupon type, a coupon value, a product category, a merchant category, a merchant, a manufacturer, a start date, an expiration date, a quantity, date of redemption, time of redemption, and a restriction on redemption.

16. The system of claim 12, wherein the authorization request further includes product data, and wherein the new coupon redemption data entry includes the product data.

17. The system of claim 16, wherein the product data includes at least one of: a universal product code, a stock-keeping unit, a serial number, a manufacturer part number, an international standard book number, a product category, a manufacturer, a purchase amount, and a color.

18. The system of claim 12, wherein each consumer profile further includes a plurality of demographic characteristics.

19. The system of claim 18, wherein the at least one coupon redemption characteristic are further based on the plurality of demographic characteristics included in the specific consumer profile.

20. The system of claim 18, wherein the plurality of demographic characteristics includes at least one of: age, gender, income, zip code, postal code, residential status, residential type, education, familial status, and occupation.

21. The system of claim 18, wherein the plurality of demographic characteristics are not personally identifiable to the related consumer.

22. The method of claim 1, wherein creating a new coupon redemption data entry includes identifying, in a coupon database, a coupon data entry corresponding to the coupon including redeemed coupon data and the redeemed coupon identifier, and wherein the coupon data included in the new coupon redemption data entry includes the redeemed coupon data in the identified coupon data entry.
